(19) United States
(12) Patent Application Publication
(10) Pub. No.: US 2024/0381011 A1
(43) Pub. Date: Nov. 14, 2024

(54) CONTROL APPARATUS, CONTROL METHOD, AND COMPUTER READABLE MEDIUM

(71) Applicant: NEC Corporation, Tokyo (JP)

(72) Inventor: Shigeyuki YANAGIMACHI, Tokyo (JP)

(73) Assignee: NEC Corporation, Tokyo (JP)

(21) Appl. No.: 18/643,205

(22) Filed: Apr. 23, 2024

(30) Foreign Application Priority Data
May 11, 2023 (JP) 2023-078282

(51) Int. Cl. H04Q 11/00; H04B 10/079; H04B 10/25

(52) U.S. Cl. CPC H04Q 11/0062; H04B 10/07953; H04B 10/25; H04Q 2011/0073

(57) ABSTRACT

To improve transmission quality in a network using an MCF, a control apparatus is provided including: a reception unit that receives a request for setting an optical communication route from a start point node to an end point node; and a control unit that sets a route using a first core included in a plurality of cores of a multi core optical fiber (MCF) used in the start point node, based on quality of an optical transmission route in each of the plurality of cores.

### INCORPORATION BY REFERENCE

This application is based upon and claims the benefit of priority from Japanese patent application No. 2023-078282, filed on May 11, 2023, the disclosure of which is incorporated herein in its entirety by reference.

### TECHNICAL FIELD

The present disclosure relates to a control apparatus, a control method, a program, and an optical communication system.

### BACKGROUND ART

In recent years, traffic flowing through a network has increased due to a spread of a terminal such as a smartphone and large-capacity data communication such as a high definition image by the terminal. According to a certain survey, total download traffic by broadband subscribers in the domestic fiscal year of 2020 is about 19 Tbps and continues to increase at an annual rate of about 57%, and traffic is expected to increase in the future.

In contrast, in a core network supporting large-capacity communication, a large-capacity technique such as a wavelength division multiplexing (WDM) technique of multiplexing optical signals having a plurality of different wavelengths into one optical fiber and transmitting the multiplexed optical signals, and an advanced modulation system such as dual polarization quadrature phase shift keying (DP-QPSK) or 16 quadrature amplitude modulation (16-QAM) has been developed. However, since the number of wavelengths usable in WDM is limited, it is expected that an increase in communication capacity by WDM reaches a plateau in the near future.

Further, even in these advanced modulation systems, an S/N requirement of a signal is severe, and thus, a limit such as a limited arrival distance is approaching. In contrast, in recent years, in order to increase a transmission capacity per optical fiber, research and development of a multi core optical fiber (MCF) that fills a plurality of cores in a single cladding is also proceeding instead of a conventional single mode optical fiber (SMF).

As described above, although research and development for increasing the capacity is proceeding, research and development for effectively utilizing a limited frequency resource is also proceeding. For example, in an elastic accommodation technique, a conventional WDM wavelength interval is shortened, and thereby frequency utilization efficiency is increased. Furthermore, from a viewpoint of network control, for example, there is an effort to reduce blocking of a path by allocating a path in response to quality of an optical transmission route, a band of a communication signal, and a communication distance, and thereby increase the frequency utilization efficiency.

For example, Patent Literature 1 (International Patent Publication No. WO2022/244236) discloses a technique of selecting a core, a link, and an optical path route that accommodate an optical path by leveling a wavelength usage situation of an entire network, based on usage situation information of multi core fibers of all links.

### SUMMARY

However, the technique described in Patent Literature 1 has room for further improving transmission quality.

In view of the above-described problem, an example object of the present disclosure is to provide a technique being capable of improving transmission quality in a network using an MCF.

In a first example aspect of the present disclosure, a control apparatus includes: a reception unit configured to receive a request for setting an optical communication route from a start point node to an end point node; and a control unit configured to set a route using a first core included in a plurality of cores of a multi core optical fiber (MCF) used in the start point node, based on quality of an optical transmission route in each of the plurality of cores.

Further, in a second example aspect of the present disclosure, a control method includes: receiving a request for setting an optical communication route from a start point node to an end point node; and setting a route using a first core included in a plurality of cores of a multi core optical fiber (MCF) used in the start point node, based on quality of an optical transmission route in each of the plurality of cores.

Further, in a third example aspect of the present disclosure, a program causes a computer to execute processing of: receiving a request for setting an optical communication route from a start point node to an end point node; and setting a route using a first core included in a plurality of cores of a multi core optical fiber (MCF) used in the start point node, based on quality of an optical transmission route in each of the plurality of cores.

Further, in a fourth example aspect of the present disclosure, an optical communication system includes: a start point node; an end point node; a reception unit configured to receive a request for setting an optical communication route from the start point node to the end point node; and a control unit configured to set a route using a first core included in a plurality of cores of a multi core optical fiber (MCF) used in the start point node, based on quality of an optical transmission route in each of the plurality of cores.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram illustrating one example of a configuration of an optical communication system according to an example embodiment;

FIG. 2 is a diagram illustrating one example of a configuration of a node according to the example embodiment;

FIG. 3 is a diagram illustrating one example of a control apparatus according to the example embodiment;

FIG. 4 is a diagram illustrating a hardware configuration example of the control apparatus according to the example embodiment;

FIG. 5 is a flowchart illustrating one example of processing of the control apparatus according to the example embodiment;

FIG. 6 is a diagram illustrating one example of information stored in a core management database (DB) according to the example embodiment;

FIG. 7 is a diagram illustrating one example of a route according to the example embodiment;

FIG. 8 is a flowchart illustrating one example of processing of the node according to the example embodiment;

FIG. 9 is a diagram illustrating one example of a simulation result of quality of an optical transmission route in a network using an MCF; and

FIG. 10 is a diagram illustrating one example of a cross section of a 7-core MCF according to the example embodiment.

### EXAMPLE EMBODIMENT

A principle of the present disclosure is described with reference to several example embodiments. It should be understood that these example embodiments are described for a purpose of exemplification only and assists those of ordinary skill in the art in understanding and practicing the present disclosure without suggesting limitations on the scope of the present disclosure. The disclosure described in the present specification is implemented in a variety of ways other than those described below.

In the following description and claims, unless otherwise defined, all technical and scientific terms used in the present specification have the same meaning as commonly understood by those of ordinary skill in the art to which the present disclosure belongs.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Hereinafter, an example embodiment of the present disclosure will be described with reference to the drawings.

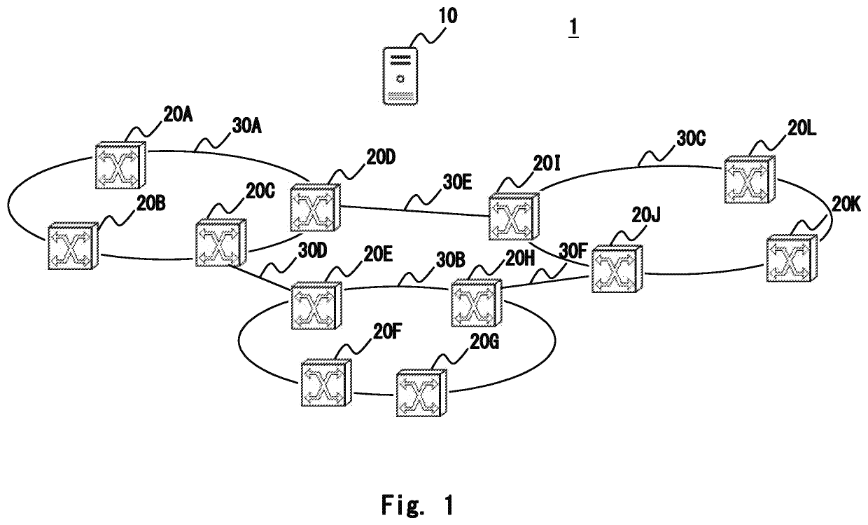

A configuration of an optical communication system 1 according to the example embodiment will be described with reference to FIG. 1.

### System Configuration

FIG. 1 is a diagram illustrating one example of a configuration of the optical communication system 1 according to the example embodiment. In the example in FIG. 1, the optical communication system 1 includes a control apparatus 10. Note that, the control apparatus 10 may be referred to as, for example, a network management system (NMS), or the like. Further, the optical communication system 1 includes nodes 20A to 20L (hereinafter, simply referred to as a “node 20” when there is no need to distinguish with one another). Note that, the number of the control apparatuses 10 and the nodes 20 is not limited to the example in FIG. 1.

The control apparatus 10 and each node 20 are connected in such a way as to be communicable with one another via a not-illustrated optical transmission route (e.g., an optical fiber), for example. The nodes 20A to 20D are connected in such a way as to be communicable with one another via an optical transmission route 30A. Further, the nodes 20E to 20H are connected in such a way as to be communicable with one another via an optical transmission route 30B. Further, the nodes 20I to 20L are connected in such a way as to be communicable with one another via an optical transmission route 30C.

Further, the node 20C and the node 20E are connected in such a way as to be communicable with each other via an optical transmission route 30D. Further, the node 20D and the node 20I are connected in such a way as to be communicable with each other via an optical transmission route 30E. Further, the node 20H and the node 20J are connected in such a way as to be communicable with each other via an optical transmission route 30F. Note that, the optical transmission routes 30A to 30F may include an optical amplifier that compensates for a transmission loss of light.

Note that, in the example in FIG. 1, a network topology of the optical transmission routes 30A to 30C is a ring type, but the present disclosure is not limited thereto. The network topology of each node 20 may be, for example, a point-to-point type, a star type, a mesh type, or the like.

### Configuration of Node 20

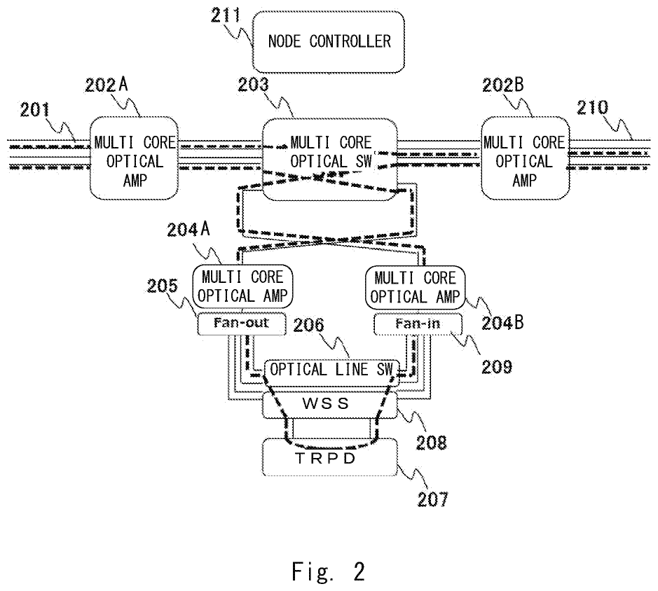

Next, a configuration of the node 20 according to the example embodiment will be described with reference to FIG. 2. FIG. 2 is a diagram illustrating one example of the configuration of the node 20 according to the example embodiment.

The node 20 includes an input multi core optical fiber (MCF) 201, a multi core optical amplifier 202A, a multi core optical switch 203, a multi core optical amplifier 204A, a fan-out 205, an optical line switch 206, a wavelength selective switch (WSS) 208, a transponder (TRPD) 207, a fan-in 209, a multi core optical amplifier 204B, a multi core optical amplifier 202B, an output MCF 210, and a node controller 211.

Each of the input MCF 201 and the output MCF 210 is an optical fiber (MCF) in which a plurality of cores are disposed in one cladding. Note that, in an MCF, since different pieces of data can be transmitted for each core, a data amount (transmission capacity) that can be transmitted by one fiber can be increased.

Note that, a multiplexing system such as an MCF is also referred to as a space division multiplexing (SDM).

Each of the input MCF 201 and the output MCF 210 may be, for example, an uncoupled MCF being an optical fiber spaced apart between cores and having reduced crosstalk between the cores. In this case, each of the input MCF 201 and the output MCF 210 may be, for example, an uncoupled MCF having seven cores. Note that, in an uncoupled MCF, since each core can be used as an independent optical transmission route, it is possible to utilize (divert) at least a part of an optical communication technique developed for a conventional SMF.

The input MCF 201 inputs an optical signal from another node 20. The multi core optical amplifier 202A compensates a transmission loss of the input MCF 201 in a multi core fiber unit. The multi core optical switch 203 performs switching, in a multi core unit, of the MCF from the multi core optical amplifier 202A.

The multi core optical amplifier 204A compensates for a loss of an optical signal from a drop port of the multi core optical switch 203. The fan-out 205 divides an optical signal of a multi core unit from the multi core optical amplifier 204A in a single core unit. The optical line switch 206 switches an optical signal of the single core unit from the fan-out 205.

The WSS 208 performs switching in a wavelength unit, and performs add/drop to the TRPD 207. The TRPD 207 receives traffic from the WSS 208, or transmits traffic to the WSS 208. The fan-in 209 bundles optical signals of the single core unit from the WSS 208 into the multi core unit. The multi core optical amplifier 204B compensates for a loss of an optical signal of the multi core unit from the fan-in 209.

Further, the multi core optical switch 203 receives an optical signal of the multi core optical amplifier 204B from an add port, and performs switching in the multi core unit. The multi core optical amplifier 202B compensates for a loss of an optical signal from the multi core optical switch 203. The output MCF 210 transmits an optical signal from the multi core optical amplifier 202B. The node controller 211 controls each device in the node 20.

### Configuration of Control Apparatus 10

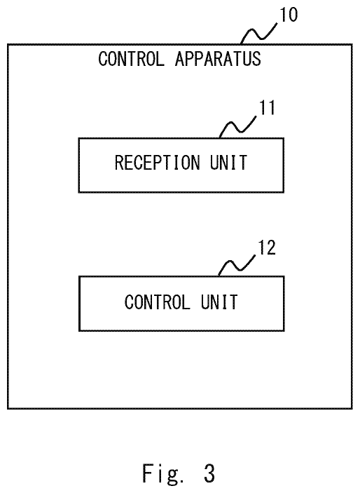

Next, a configuration of the control apparatus 10 according to the example embodiment will be described with reference to FIG. 3. FIG. 3 is a diagram illustrating one example of the configuration of the control apparatus 10 according to the example embodiment. The control apparatus 10 includes a reception unit 11, and a control unit 12. Each of these units may be achieved by cooperation of one or more programs installed in the control apparatus 10 and hardware such as a processor 101 and a memory 102 of the control apparatus 10.

The reception unit 11 receives, from a start point node, a request (path request) for setting a route (optical communication route) from the node 20 (start point node) transmitting data to the node 20 (end point node) receiving data.

The control unit 12 sets a route using a first core included in a plurality of cores of a multi core optical fiber (MCF) used in the start point node, based on quality of an optical transmission route in each of the plurality of cores.

### Hardware Configuration

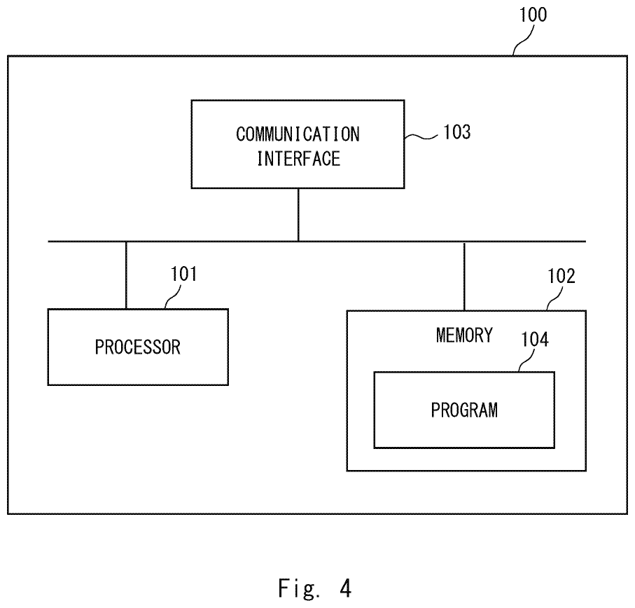

FIG. 4 illustrates an example of a hardware configuration of a control apparatus 10 according to the example embodiment. In the example illustrated in FIG. 4, the control apparatus 10 (a computer 100) includes the processor 101, the memory 102, and a communication interface 103. These components may be connected to each other through a bus or the like. The memory 102 stores at least a part of a program 104. The communication interface 103 includes an interface necessary for communicating with other network elements.

When the program 104 is executed through the cooperation of the processor 101, the memory 102, and the like, at least one of the processes of the example embodiment according to the present disclosure is performed by the computer 100. The memory 102 may be of any type suitable for a local technology network. The memory 102 may be, but is not limited to, a non-transitory computer readable storage medium. Further, the memory 102 may be implemented by using any suitable data storage technology such as a semiconductor-based memory device, a magnetic memory device and system, an optical memory device and system, a fixed memory, and a removable memory. Although only one memory 102 is provided in the computer 100, a plurality of physically different memory modules may be provided in the computer 100. The processor 101 may be of any type. The processor 101 may include at least one of a general-purpose computer, a dedicated computer, a microprocessor, a digital signal processor (DSP: Digital Signal Processor), and, as a non-limiting example, a processor based on a multi-core processor architecture. The computer 100 may include a plurality of processors, such as an application-specific integrated circuit chip that is temporally dependent on a clock for synchronizing the main processor.

An example embodiment according to the present disclosure may be implemented by hardware, a dedicated circuit, software, a logic, or any combination thereof. In some aspects, the example embodiment may be implemented by hardware, while in other aspects, the example embodiment may be implemented by firmware or software that may be executed by a controller, a microprocessor, or other computing devices.

The present disclosure also provides at least one computer program product that is tangibly stored in a non-transitory computer readable storage medium. The computer program product contains computer executable instructions, such as those contained in program modules, and is executed by a target real processor or by a device on a virtual processor, so that a process(es) or a method according to the present disclosure is performed. The program module contains routines, programs, libraries, objects, classes, components, and data structures for performing specific tasks or implement specific abstract data types. The functions of the program module may be combined with those of the other program modules, or divided into a plurality of program modules as desired in various example embodiments. The machine executable instructions in the program module can be executed locally or in a distributed device(s). In the distributed device, the program module can be disposed on both local and remote storage media.

The program codes for performing the method according to the present disclosure may be written in any combination of at least one programming language. These program codes are provided to a processor or a controller of a general-purpose computer, a dedicated computer, or other programmable data processors. These program codes are provided to a processor or a controller of a general-purpose computer, a dedicated computer, or other programmable data processing apparatuses, and when such a program code is executed by the processor or the controller, a function/operation in a flowchart and/or a block diagram to be implemented is executed. The program code is entirely executed in a machine, partially executed in a machine as a standalone software package, partially executed in a machine, partially executed in a remote machine, or entirely executed in a remote machine or a server.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

### Processing

### Processing of Control Apparatus 10

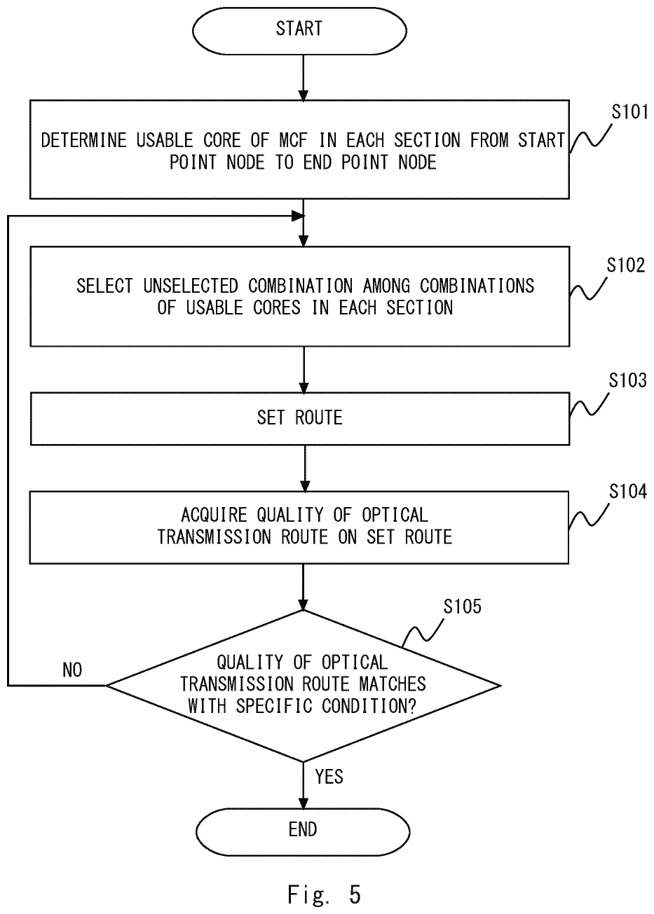

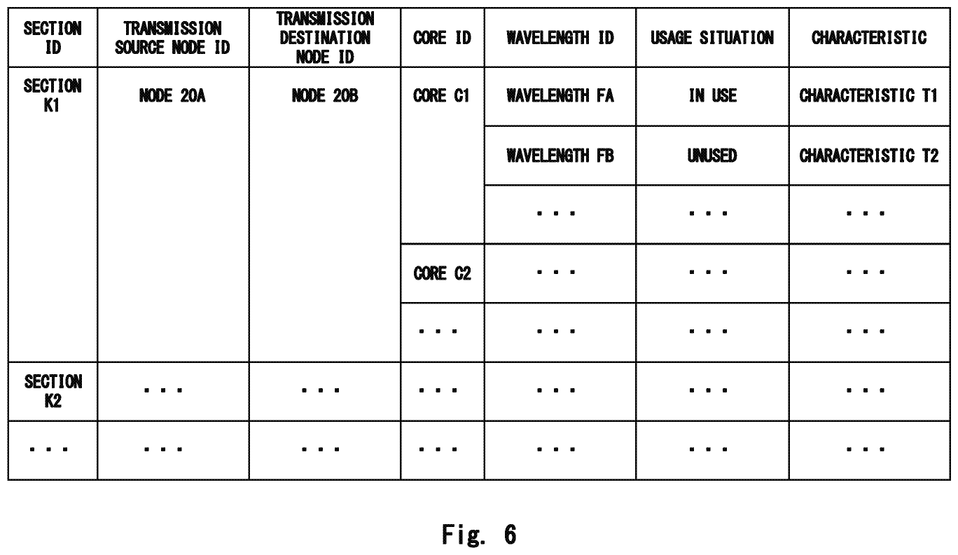

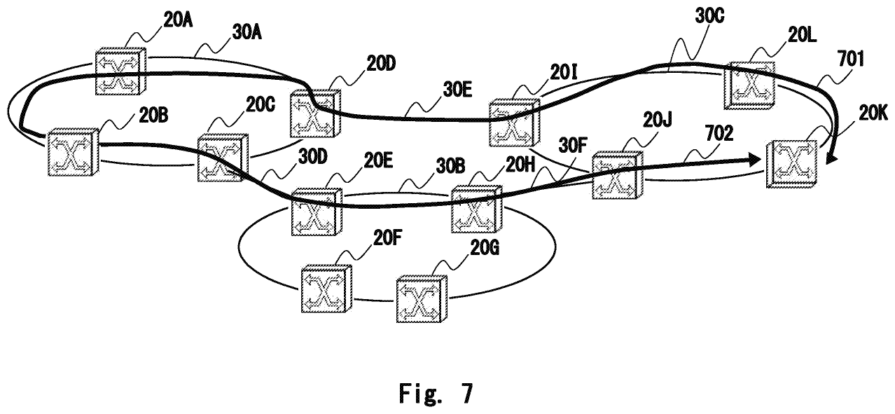

Next, one example of processing of the control apparatus 10 according to the example embodiment will be described with reference to FIGS. 5 to 7. FIG. 5 is a flowchart illustrating one example of processing of the control apparatus 10 according to the example embodiment. FIG. 6 is a diagram illustrating one example of information recorded in a core management database (DB) 601 according to the example embodiment. FIG. 7 is a diagram illustrating one example of a route according to the example embodiment.

Note that, the processing in FIG. 5 may be executed, for example, when the reception unit 11 of the control apparatus 10 receives, from the start point node, a request (path request) for setting a route from the node 20 (start point node) transmitting data to the node 20 (end point node) receiving data. Note that, the path request may include, for example, identification information of the start point node and identification information of the end point node.

In step S101, the control unit 12 refers to the core management DB 601, and determines one or more cores of an MCF that are usable (free and unused) in each section on the route from the start point node to the end point node. In the present disclosure, a section refers to a transmission route from a certain node 20 to another node 20 on a route from the start point node to the end point node.

Herein, the control unit 12 may determine a route in which the number (the number of hops) of relay nodes on the route (a node 20 other than the start point node 20 and the end point node 20 among each of the nodes 20 on the route) is the smallest.

Further, the control unit 12 may determine a route being capable of transmitting an optical signal with the same wavelength in a route from the start point node to the end point node with reference to the core management DB 601. As a result, for example, wavelength shifting at the relay node becomes unnecessary, and thus, a transmission delay in the route from the start point node to the end point node can be further reduced. In this case, for example, the control unit 12 may determine a usable (free or unused) wavelength in each section.

In the example in FIG. 6, in the core management DB 601, a transmission source node ID and a transmission destination node ID are recorded in association with a section ID. Further, a usage situation and a characteristic are recorded in association with a combination of the section ID, a core ID, and a wavelength ID.

The section ID is identification information of the section. The transmission source node ID is identification information of the node 20 of a transmission source side to which an MCF of the section is connected. The transmission destination node ID is identification information of the node 20 of a transmission destination side to which the MCF of the section is connected.

The core ID is identification information of a core included in the MCF of the section. The wavelength ID is identification information of a wavelength of an optical signal that can be transmitted by the core. The usage situation is a usage situation at the wavelength in the core. The usage situation may include “in use” indicating that an optical signal is being transmitted at the wavelength in the core, and “unused” indicating that an optical signal is not being transmitted at the wavelength in the core. The characteristic is a characteristic related to transmission according to the core at the section. The characteristic may include, for example, information such as a transmission speed and a transmission distance.

In the example in FIG. 6, it is illustrated that, in the section from the node 20A to the node 20B, a wavelength FA is in use in a core C1, and a wavelength FB is usable due to unused (not in use).

Note that, the core management DB 601 may be recorded in a storage apparatus inside the control apparatus 10, or may be recorded in a storage apparatus outside the control apparatus 10. The information on the section ID, the transmission source node ID, the transmission destination node ID, the core ID, and the wavelength ID in the core management DB 601 may be set (registered) in advance by, for example, an administrator or the like of the control apparatus 10. The information on the usage situation in the core management DB 601 may be recorded (updated) by the control unit 12, for example, when the control unit 12 sets and releases a route.

Subsequently, the control unit 12 selects an unselected combination among combinations of usable cores in each section on the route (step S102). Herein, for example, the control unit 12 uses a first core in a first multi core optical fiber at a first section from the start point node to a relay node, and selects a route using a second core in a second multi core optical fiber at a second section from the relay node to the end point node.

Subsequently, the control unit 12 sets a route using a combination of selected cores in each section with a specific wavelength (step S103). Herein, the control unit 12 may transmit each command for setting a route to each node 20 on the route.

Subsequently, the control unit 12 acquires (calculates, estimates, and determines) quality of transmission of an optical signal on the set route (quality of an optical transmission route) with respect to a specific wavelength (step S104). Herein, for example, the control unit 12 may calculate an optical signal to noise ratio (OSNR) as a value indicating the quality.

### (An Example of Calculating Quality of an Optical Transmission Route by at Least One of the End Node 20 and the Relay Node 20)

The control unit 12 may acquire information indicating quality of transmission of an optical signal calculated (measured) by at least one of the end point node 20 and the relay node 20, from the node 20 that has been calculated. In this case, each node 20 may have a monitor (measurement apparatus) for measuring quality such as an OSNR, based on an output from the fan-out 205 or the like, for example.

In this case, each node 20 may execute determination processing in step S105 described later. Then, each node 20 may notify the control apparatus 10 of a determination result. Alternatively, when the quality of transmission of an optical signal is equal to or less than a threshold value, each node 20 may transmit, to the node 20 of the transmission source, a request for using another core other than a core used for current transmission. Then, the transmission source node 20 that has received the request may switch to the another core and transmit an optical signal.

### (An Example of Estimating Quality of an Optical Transmission Route by the Control Apparatus 10)

The control unit 12 may estimate at least one of quality of an optical transmission route at all sections on a route, and the quality of the optical transmission route at each section on the route, based on the usage situation of each of a plurality of cores of an MCF. In this case, the control unit 12 may, for example, refer to the core management DB 601, and estimate (simulate) an amount of crosstalk in each core with a specific wavelength at each section, based on a specific mathematical expression. Then, for example, the control unit 12 may estimate a value of the quality (for example, OSNR) of the optical transmission route at all the sections on the route, based on the amount of crosstalk in each core with a specific wavelength at each section.

Subsequently, the control unit 12 determines whether the quality of the optical transmission route matches with a specific condition (step S105). When the quality of the optical transmission route is equal to or more than a threshold value, the control unit 12 may determine that the quality of the optical transmission route matches with the specific condition. Further, when the quality of the optical transmission route is the highest value in a combination of usable cores at each section on the route, the control unit 12 may determine that the quality of the optical transmission route matches with the specific condition.

When the quality of the optical transmission route does not match with the specific condition (NO in step S105), the processing proceeds to step S102. In the processing of step S102 again, the control unit 12 uses, for example, a third core different from the first core in the first multi core optical fiber at the first section from the start point node to the relay node, and selects a route using the second core in the second multi core optical fiber at the second section from the relay node to the end point node. As a result, for example, in a network using an MCF, even when crosstalk (mixture, interference, cross talk, contact) occurs between the cores, it is possible to appropriately select the cores used in the MCF of each section on the route. On the other hand, when the quality of the optical transmission route matches with the specific condition (YES in step S105), the processing is ended.

With reference to FIG. 7, a case where the node 20B is a start point node and the node 20K is an end point node will be described as an example. In this case, the control unit 12 may select, for example, a first route 701 being transmitted through relay nodes in order of the node 20A, the node 20D, the node 20I, and the node 20L and having the minimum number of hops. Then, the control unit 12 may select, for example, a second route 702 being transmitted through relay nodes in order of the node 20C, the node 20E, the node 20H, and the node 20J and having the minimum number of hops.

Then, the control unit 12 may select, for each of the first route 701 and the second route 702, a combination in which the quality of the optical transmission route is the highest or equal to or more than the threshold value for each combination of the core and the wavelength used in each section.

### Processing of Node 20

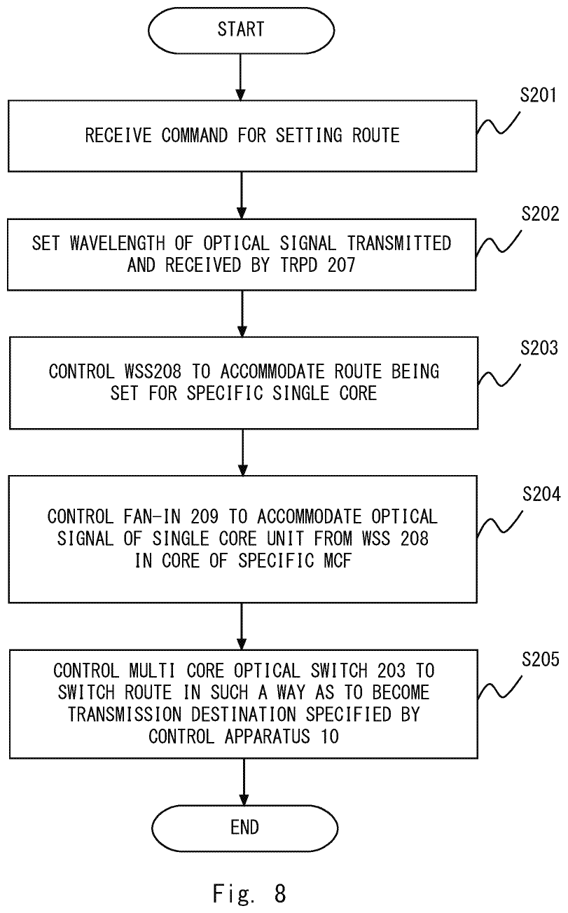

Next, one example of processing of the node 20 according to the example embodiment will be described with reference to FIG. 8. FIG. 8 is a flowchart illustrating one example of processing of the node 20 according to the example embodiment. The processing in FIG. 8 may be executed when each command from the control apparatus 10 is received at each node 20 on a route.

In step S201, the node controller 211 receives a command for setting a route from the control apparatus 10. Herein, the command may include information indicating a section (e.g., identification information of the node 20 of the transmission source, and identification information of the node 20 of the transmission destination), the core ID, and the wavelength ID.

Subsequently, the node controller 211 controls the TRPD 207 to set (adjust) a wavelength of an optical signal transmitted and received by the TRPD 207 to a wavelength specified by the control apparatus 10 (step S202).

Subsequently, the node controller 211 controls the WSS 208 to accommodate a route being set to a specific single core (to transmit an optical signal) (step S203).

Subsequently, the node controller 211 controls the fan-in 209 to accommodate the optical signal of the single core unit from the WSS 208 in a core of a specific MCF (step S204).

Subsequently, the node controller 211 controls the multi core optical switch 203 to switch a route in such a way as to become the transmission destination specified by the control apparatus 10 (step S205). Note that, in the relay node 20, the node controller 211 controls the optical line switch 206 to switch a core.

### Others

In a network using an MCF, even in an uncoupled optical fiber in which each core is provided at a pitch such that crosstalk does not occur in an optical fiber, some crosstalk between cores occurs. Thus, in the network using the MCF, there is a possibility that a transmission characteristic deteriorates as compared with a network using a single core fiber.

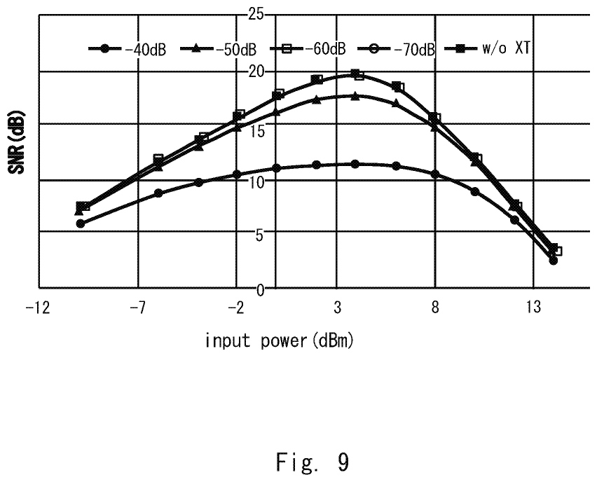

FIG. 9 is a diagram illustrating one example of a simulation result of quality of an optical transmission route in a network using an MCF. In FIG. 9, a horizontal axis represents input optical power per channel, and a vertical axis represents an SNR. Conditions in the simulation are 80 wavelengths at intervals of 50 GHz, channel speed of 100 Gbps, a transmission distance of 575 km (e.g., between Tokyo and Osaka), and a number of hops of 6. FIG. 9 illustrates an estimation value of OSNR for each value of crosstalk between cores from −40 dB to infinitesimal (w/o) under the conditions. According to FIG. 9, it can be seen that the OSNR deteriorates as the crosstalk between cores increases.

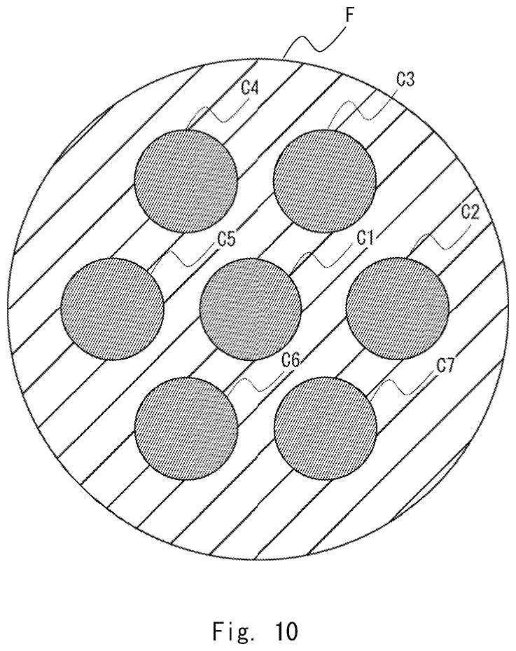

FIG. 10 is a diagram illustrating one example of a cross section of a 7-core MCF according to the example embodiment. In the example in FIG. 10, cores C1 to C7 are provided in one optical fiber F. The core C1 being a core of the central portion has a larger number of adjacent cores as compared with the other cores C2 to C7, and thus may have a poor crosstalk characteristic. Further, for example, in the core C2, when any of the adjacent cores C3, C1, and C7 is used at a specific wavelength, there is a possibility that a characteristic of crosstalk in the core C2 deteriorates. In other words, it is considered that quality of an optical transmission route may depend on a core used in each section (a link between nodes) on a route.

Meanwhile, according to the present disclosure, a route using a specific core included in a plurality of cores of an MCF used in the start point node is set based on quality of an optical transmission route in each of the plurality of cores. Thus, in a network using an MCF, transmission quality can be improved

### Modification Example

The control apparatus 10 may be an apparatus included in one housing, but the control apparatus 10 of the present disclosure is not limited thereto. Each unit of the control apparatus 10 may be achieved by, for example, cloud computing constituted by one or more computers. Further, the control apparatus 10 and the node 20 may be accommodated in the same housing and configured as an integrated control apparatus.

Further, the node controller 211 (control apparatus) or the like of the node 20 may execute processing of at least a part of each functional unit of the control apparatus 10. Such a control apparatus is also included in one example of a “control apparatus” of the present disclosure.

An example advantage according to the above-described example embodiment is capable of improving transmission quality in a network using an MCF.

Each of the above-described example embodiments can be combined as desirable by one of ordinary skill in the art.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

The whole or part of the example embodiments disclosed above can be described as, but not limited to, the following supplementary notes.

### Supplementary Note 1

A control apparatus including:
a reception unit configured to receive a request for setting an optical communication route from a start point node to an end point node; and
a control unit configured to set a route using a first core included in a plurality of cores of a multi core optical fiber (MCF) used in the start point node, based on quality of an optical transmission route in each of the plurality of cores.

### Supplementary Note 2

The control apparatus according to supplementary note 1, wherein the control unit uses the first core in a first multi core optical fiber at a first section from the start point node to a relay node, and sets a route using a second core included in a plurality of cores of a second multi core optical fiber at a second section from the relay node to the end point node, based on quality of an optical transmission route in each of the plurality of cores.

### Supplementary Note 3

The control apparatus according to supplementary note 2, wherein the control unit sets a route being capable of transmitting an optical signal with the same wavelength from the start point node to the end point node.

### Supplementary Note 4

The control apparatus according to supplementary note 1, wherein quality of the optical transmission route is an optical signal to noise ratio measured at the end point node.

### Supplementary Note 5

The control apparatus according to supplementary note 1, wherein the control unit estimates quality of the optical transmission route, based on a usage situation of each of a plurality of cores of the multi core optical fiber.

### Supplementary Note 6

A control method including:
receiving a request for setting an optical communication route from a start point node to an end point node; and
setting a route using a first core included in a plurality of cores of a multi core optical fiber (MCF) used in the start point node, based on quality of an optical transmission route in each of the plurality of cores.

### Supplementary Note 7

A program causing a computer to execute processing of
receiving a request for setting an optical communication route from a start point node to an end point node; and
setting a route using a first core included in a plurality of cores of a multi core optical fiber (MCF) used in the start point node, based on quality of an optical transmission route in each of the plurality of cores.

### Supplementary Note 8

An optical communication system including:
a start point node;
an end point node;
a reception unit configured to receive a request for setting an optical communication route from the start point node to the end point node; and
a control unit configured to set a route using a first core included in a plurality of cores of a multi core optical fiber (MCF) used in the start point node, based on quality of an optical transmission route in each of the plurality of cores.

What is claimed is:

1. A control apparatus comprising:
a reception unit configured to receive a request for setting an optical communication route from a start point node to an end point node; and
a control unit configured to set a route using a first core included in a plurality of cores of a multi core optical fiber (MCF) used in the start point node, based on quality of an optical transmission route in each of the plurality of cores.

2. The control apparatus according to claim 1, wherein the control unit uses the first core in a first multi core optical fiber at a first section from the start point node to a relay node, and sets a route using a second core included in a plurality of cores of a second multi core optical fiber at a second section from the relay node to the end point node, based on quality of an optical transmission route in each of the plurality of cores.

3. The control apparatus according to claim 2, wherein the control unit sets a route being capable of transmitting an optical signal with the same wavelength from the start point node to the end point node.

4. The control apparatus according to claim 1, wherein quality of the optical transmission route is an optical signal to noise ratio measured at the end point node.

5. The control apparatus according to claim 1, wherein the control unit estimates quality of the optical transmission route, based on a usage situation of each of a plurality of cores of the multi core optical fiber.

6. A control method comprising:
receiving a request for setting an optical communication route from a start point node to an end point node; and
setting a route using a first core included in a plurality of cores of a multi core optical fiber (MCF) used in the start point node, based on quality of an optical transmission route in each of the plurality of cores.

7. A non-transitory computer readable medium storing a program causing a computer to execute processing of:
receiving a request for setting an optical communication route from a start point node to an end point node; and
setting a route using a first core included in a plurality of cores of a multi core optical fiber (MCF) used in the start point node, based on quality of an optical transmission route in each of the plurality of cores.
